(19) United States
(12) Patent Application Publication
(10) Pub. No.: US 2024/0333121 A1
(43) Pub. Date: Oct. 3, 2024

(54) Magnetodynamic proplsion system

(71) Applicant: Harold A. Tavarez, Downey, CA (US)

(72) Inventor: Harold A. Tavarez, Downey, CA (US)

(21) Appl. No.: 18/445,072

(22) Filed: Mar. 29, 2023

(51) Int. Cl. H02K 99/00

(52) U.S. Cl. CPC H02K 99/20

(57) ABSTRACT

A Magnetodynamic propulsion system generates propellantless thrust with the magnetic field interactions between an axial magnetic field and a radial magnetic field. The propulsion system comprises a motor to convey rotary motion to a rotor magnet generating an axial magnetic field; for magnetic interaction with a stator magnet generating a radial magnetic field. The rotor magnet generates a magnetic field in motion that interacts magnetically with the stationary magnetic field, wherein the motion through the stationary magnetic field space in the stator magnet; generates Lorentz forces as propellantless thrust for propulsion without propellant, without and equal and opposite reaction, and without reliance on an external mass to react against.

### CROSS-REFERENCE TO RELATED APPLICATIONS

This application claims the benefit of provisional patent application Ser. No. 63/372,791 filed 2022 Apr. 4 by the present inventor.

### FEDERALLY SPONSORED RESEARCH

Not Applicable

### SEQUENCE LISTING OR PROGRAM

Not Applicable

### BACKGROUND

### Field

The present application relates to the magneto-dynamic interactions between angularly disposed magnetic fields to generate propulsion without propellant, without reaction, and without an external mass to react against.

### Prior Art

In the present state of propulsion technology, transportation on land, air, water, and in the vacuum of space; employ prime movers that rely on propellant. Each of these modes of transportation and travel requires a dedicated and specific propulsion system.

In that regard, replacing propellant dependent propulsion with propulsion without propellant is a more advantageous, useful, and a better energy efficient approach. Accordingly, propulsion without propellant is of great benefit for all modes of transportation, and at the same time, helps the environment with the elimination of all the pollution producing propellants.

Propulsion without the expulsion of propellant, without reaction, and without an external mass to react against is useful for all means of transportation that travel on land, air, water, and in the vacuum of space.

For propulsion, the electric motor and the internal combustion engine with a drive train delivers the power to drive the wheels of land driven motor vehicles. The ground in contact with the wheels is the propellant. In aerospace, gas turbine engines rely on the air in the atmosphere. Propellers employ the available air and water as propellant. In space travel; the propellant available for thrust is a major limitation.

Practical space drives that generate propellantless thrust for space travel and satellites in orbit are still a dream not yet fully realized; but not for the lack of efforts by the works in the field. So far, all the available modes of propulsion have limited capabilities due to the limitations imposed by the inherent dependence on propellant.

Example of propellantless propulsion systems in the prior art shows.

Purvis U.S. Pat. No. 10,006,446 B2 utilizes multi-element capacitor with segmented rotating cathodes interacting with electromagnetic coils generating magnetic fields.

Purvis U.S. Pat. No. 10,135,323 B2 discloses an apparatus and method of propulsion utilizing capacitor assemblies and electromagnetic Helmholtz coils to generate propellantless thrust.

Delroy U.S. Pat. No. 5,090,260 discloses a gyroscopic propulsion system for producing a controlled unidirectional movement in a predetermined direction based on gyrostatic precession.

Rodgers U.S. Pat. No. 5,054,331 is a controllable gyroscopic propulsion apparatus that develop a controllable propulsion force in a desired direction.

Kethly U.S. Pat. No. 4,784,006 discloses a gyroscopic propulsion device that generates a propulsion force with an annular body rotating about an eccentric second axis in the body.

### SUMMARY OF THE INVENTION

The present propulsion system generates propellantless thrust with the magnetic interactions between angularly disposed magnetic fields. The thrust is produced with the ejection of propellant, without an equal and opposite reaction, and without reliance of an external body to react against. At a minimum, the most basic elements for propulsion are a motor as the means to drive a rotor generating an axially disposed magnetic field for magnetic interaction with an angularly disposed and radially disposed magnetic field.

The embodiment of the propulsion method and operation comprises a rotor with a single or a plurality of magnets as sources of magnetic field; such as permanent magnets or electromagnets. The rotor carrying magnet is driven by motor means such as an electric motor or other mechanical motor means of motion to spin the rotor. Gyrations of the rotor with magnets generate a moving magnetic field. The motion of the rotor endows the rotor's magnetic field with angular momentum and energy of motion. The rotor's magnetic field in motion interacts magnetically with the stationary magnetic field from a magnet stator (a permanent magnet or an electromagnet). Accordingly, one magnetic field is stationary and the other is in motion. The magnetic interaction between the stationary magnetic field and the magnetic field in motion generates thrust and therefore propulsion without propellant.

The disclosed propulsion system employs an operation that generates propulsion by utilizing a Newton's Third Law exception with the operation that takes place in three frames of reference. The first frame is the non-inertial frame of reference of the spinning rotor. A body in motion like a spinning rotor; is a non-inertial frame of reference. As a non-inertial frame of reference, in a rotor spinning about its own geometric center of revolution, all the particles in the rotor accelerate toward the center of revolution. In the spinning rotor, particles closer to the center travel at a relative low velocity; in contrast to particles farther away from the center that travel at much higher velocities. In the spinning rotor, particles farther away from the center have by comparison a higher angular momentum and a higher kinetic energy of motion, than similar particles closer to the center of the rotor.

Similarly, in a rotor magnet spinning with a predetermined angular velocity, the outer magnetic field lines have a higher angular momentum and energy of motion in comparison with the magnetic field lines closer to the center of the magnet rotor. The lines of magnetic field in motion possess angular momentum and energy of motion; that act as sources of momentum and kinetic energy of motion and generate; the Lorentz forces that produce propellantless thrust with the dynamic magnetic field interactions between the moving and the stationary magnetic field. The rotor can have the composition of a single North-South magnetic pole magnet throughout, or a multi-poles configuration.

The second frame is an inertial frame of reference. A body at rest or a body in motion at a constant velocity is an inertial frame of reference. A stator comprising a providing a stationary magnetic field is an inertial frame of reference. Consequently, the synergy of a magnetic field in motion traversing the inertial frame of reference of an angularly disposed stationary magnetic field generates a resultant magnetic field interaction that generates Lorentz forces and therefore propellantless thrust.

The third reference frame is a magnetic field frame of reference between angularly disposed magnetic fields that employ the Newton's Third Law Exception as known in electrodynamics and modern physics. Each frame of reference cooperates with the other frames in a synergy governed by the laws of physics in the particular frame of reference.

The synergy between the operations taking place in these reference frames interact with each other and generates magnetic field interaction forces as Lorentz forces that become the thrust of propulsion. The propellantless thrust and thereby propulsion employs; the magnetic forces and the magnetic field energy present in the magnetic fields of permanent magnets and electromagnets to produce the Lorentz forces that become the propellantless propulsion thrust output of the system.

The means to generate the motion of the rotor can be an electric, mechanical, or any suitable source of torque that conveys the spinning rotor and its magnetic fields; a predetermined momentum and energy of motion. The magnetic field in motion traversing the stationary field space generates a dynamic magnetic field interaction between the stationary field and the magnetic field in motion to produce Lorentz forces for propulsion.

Similarly, two magnetic fields in motion can interact magnetically such that; the same magnetic rotor in motion under predetermined conditions interact magnetically with another magnetic rotor in motion and generate directional Lorentz forces as propellantless thrust for propulsion.

In the operation that generates propellantless thrust, the Newton's Third Law action is the motion of the rotor's magnetic field through the magnetic field space of another magnetic field. Accordingly, the dynamic magnetic field interactions between the magnetic fields generates; a directional Lorentz force without the expulsion of propellant, without an external body to react against, and without an equal and opposite Newton Third Law reaction. That operation is in accord with the recognized Newton's Third Law Exception in agreement with the established principles of electrodynamics and modern physics a first recognized by Ampère in 1820.

The present propulsion system generates propellantless thrust with the input of electric energy to an electric motor as the means that rotates the rotor with the magnets or the electromagnets supplying the magnetic field. The present application discloses the principles of reactionless and therefore a propellantless thrust output operation as new and does not appear in the prior art. Embodiments of the present invention are novel and distinct in the manner in which the propellantless thrust is produced with the angularly disposed magnetic fields. Analysis and experiments show significant improvements in the thrust output level with far-reaching and significant lower power consumption due to the elimination for propellant. There is no evidence in the prior art pertaining to the manner in which the propellantless thrust is produced as herein disclosed.

### BRIEF DESCRIPTION OF THE DRAWINGS

FIG. 1 shows Ampère's discovery on how orthogonal electric currents produce and exception to Newton's Third Law that also generate a reactionless Lorentz force.

FIG. 2 shows how the magnetic field interactions between charged particles generate a Lorentz force between the two charged particles while moving orthogonally in the same plane.

FIG. 3 shows a magnetodynamic propulsion system comprising a magnet rotor generating an axial magnetic field and a magnet stator comprising a radial magnetic field in a cooperation that generates propellantless thrust.

FIG. 4 shows an internal cross section view showing the corresponding magnet stator's radial magnetic field lines of force and the magnet rotor's axial magnetic field lines of force.

FIG. 5 shows a front view of the stator showing the stator's magnetic field with radial magnetic field lines of force extending from the annular stator magnet toward the center of the stator.

FIG. 6 shows a front view of the rotor making a magnetic field vortex comprising the rotor's axial magnetic field lines of force spinning with the rotor angular velocity movement.

FIG. 7 shows the magnet rotor magnetic field vortex shown in FIG. 6 superimposed over the stator magnetic field lines of force shown in FIG. 5.

### DETAILED DESCRIPTION OF PREFERRED EMBODIMENTS

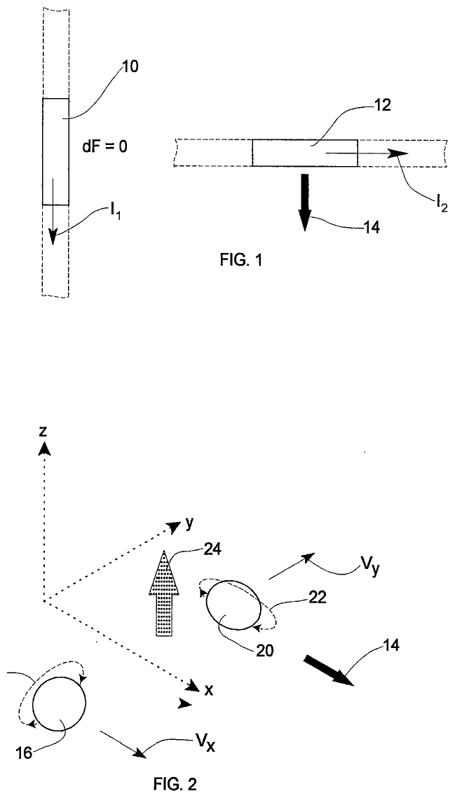

### FIG. 1

One of Ampère's findings relates to the forces between orthogonal electric currents. Ampère found out that a first electric current in one direction exerts a force on a second orthogonal electric current; while the orthogonal second current does not exert and equal and opposite force on the first current. This particular discovery by Ampère has been overlooked and ignored in propulsion because reactionless propulsion is understood to be impossible. That is until now.

FIG. 1 shows Ampère discovery in connection to orthogonal or perpendicular electric currents. In a first electric current segment 10, an electric current h1 flows in the vertical direction. While in a second current segment 12, positioned in a horizontal and perpendicular direction to the current segment 10; a second electric current I₂ flows horizontally and perpendicular to the first current I₁. In this setup, the current I₁ generates a Lorentz force 14 on the current segment 12. While the current I₂; does not exert an equal and opposite force on the current segment 10. Accordingly, the resultant force dF₁ on the current segment 10 originating from the current I₂ in the current segment 12 is zero (dF₁=0). The equal and opposite reaction as commanded by Newton's Third Law (NTL) is absent. Ampère's discovery relating the forces between perpendicular electric currents is a Newton's Third Law Exception (NTLE).

In electrodynamics and modern physics, the Lorentz force 14 is recognized as a force in violation of Newton's Third Law. Ampère discovery has been overlooked and ignored in propulsion because is only applicable to isolated electric current segments. When all the forces produced by the electric currents in complete circuits are taken into account, NTL is satisfied. And that explains why electric appliances such as computers, televisions, radios and the like; do not propel themselves with the electric currents in the circuit.

### FIG. 2

FIG. 2 shows two coplanar particles moving at right angle to each other. It is well known by those skilled in the art that a charged particle 16 (electron or proton) moving with velocity Vₓ parallel to the x-axis as shown, will exert a force on a second charged particle 20 moving orthogonally on the same plane parallel to the y-axis with velocity V_{y}.

It is also known in the art that a particle makes a magnetic field along its line of motion. And in the line of motion, particle 16 makes a magnetic field 18. Similarly, in its line of motion, charged particle 20 makes a magnetic field 22. Because the movement of charged particle 20 is perpendicular to the path of charged particle 16; the magnetic field 22 of particle 20 is also perpendicular to the magnetic field 18 of charged particle 16.

As FIG. 2 illustrates, particle 20 is in an orthogonal line of motion in relation to particle 16 and in the path of movement of magnetic field 18; producing about particle 20 an induced magnetic field 24 parallel to the z axis. The magnetic interactions between a particle 16 with magnetic field 18 and particle 20 with magnetic field 22; generates the induced magnetic field 24 that also generates the Lorentz force 14. In this orthogonal magnetic field interaction between particles and fields, particle 16 applies a force on particle 20. While particle 20 does not apply an equal and opposite reaction force on particle 16 contrary to the postulates of Newton's Third Law (NTL) “For every action there is an equal and opposite reaction.” This exception to NTL is well known, well studied and well understood by those skilled in the art and is part of electrodynamics and modern physics. NTLE takes place in the magnetic field frame of reference. The Newton's Third Law Exception (NTLE) is one situation the present propulsion system and method exploits and takes advantage of to engineer a practical and useful propellantless prime mover.

Similarly, it is well established that a charged particle (q) in motion through the magnetic field space of another magnetic field (B) generates the Lorentz force (F) perpendicular to both, the magnetic field and the velocity of the particle through the field. The magnitude of the resultant Lorentz force is approximately equal to the cross product of the particle charge, the particle velocity (V) through the field, and the angle (θ) between the particle's velocity and the field. In equation form, F=qB×V=qBV sin θ. This is the situation that applies to the description of the event taking place in FIG. 2. The resultant Lorentz force 14 is the byproduct of the magnetic field interaction between the orthogonal magnetic fields 18 and 22 in motion.

The same situation applies to the magnetic field interaction between the angularly disposed magnetic fields of permanent magnets and electromagnets to generate Lorentz forces useful as propellantless thrust for propulsion. The induced magnetic field 24 is orthogonal to the magnetic field 22. As the motion of the particle 20 with its magnetic field 22 moves across the perpendicular magnetic field 24 with the velocity V_{y}, the motion generates the Lorentz force 14 which is also perpendicular to both, the magnetic field 24 and the particle 20 velocity V_{y}.

It is well known and established that, the magnetic field of permanent magnets and energized electromagnets have North (N) and South (S) magnetic poles that interact magnetically in accordance with the rules of magnetic fields polarity and the magnetic orientation of the poles. As a general rule, unlike magnetic poles attract each other, and like magnetic poles repel each other. Moreover, the magnetic fields of permanent magnets and electromagnets in an orthogonal relationship can produce the full NTLE effect useful for making propellantless thrust. Similarly, angularly disposed permanent magnets and electromagnets are capable of producing a resultant full and/or partial NTLE effects as a byproduct of the angles between the angularly positioned magnetic fields.

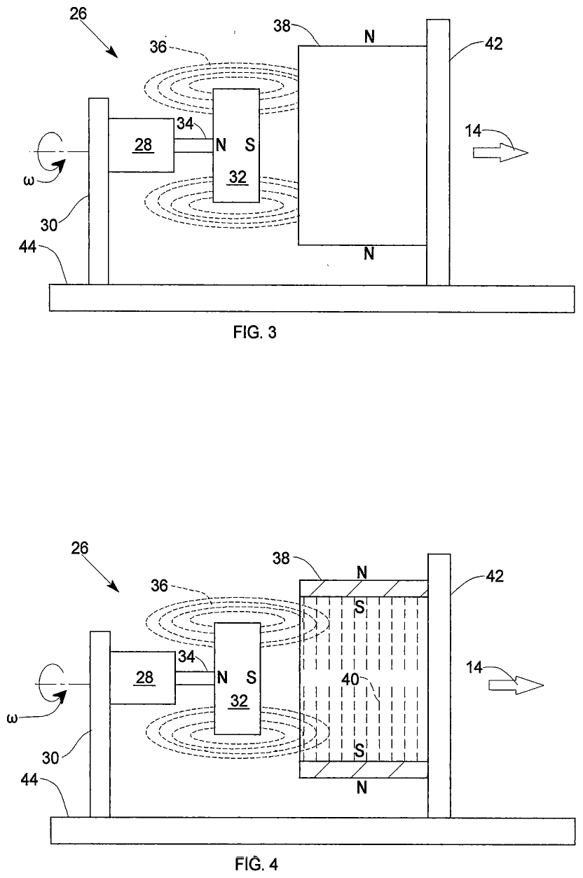

### FIG. 3 and FIG. 4

FIG. 3 and FIG. 4 illustrate a propulsion system 26 comprising motor means 28 mounted on a motor support 30, a magnet rotor 32 mounted on the motor shaft 34, generating an axial magnetic field 36, a magnet stator 38 provides a radial magnetic field 40 (best seen in FIG. 4).

The magnet stator 38 is axially disposed at a predetermined distance from the magnet rotor 32, and simultaneously, angularly disposed at a predetermined angle from the magnet rotor 32 in a predetermined alignment position that permits the axial magnetic field 36 to engage the radial magnetic field 40, in a cooperation that generate dynamic magnetic field forces. The location of the magnet 32 also includes a suitable and predetermined position about a predetermined distance within the stator 38 vicinity to allow for the partial or complete immersion of the axial magnetic field 36 within the magnetic field 40. For structural support, the magnet stator 38 attaches to a stator support 42 mounted on the base 44. The stator magnetic field 40 is stationary to provide the stationary magnetic field frame of reference that interacts magnetically with the axial magnetic field 36. The base 44 serves as the mounting frame to which the motor support 30 and the stator support 42; are attached to provide structural support to locate and align the motor 28 with the rotor 32 at a predetermined distance and position relative to the location of the stator 38. The base 44 can be a plate that can be attached to the vehicle to which the propulsion system 26 propels. Similarly, the base 44 can be the frame of the vehicles to which the propulsion system 26 propels.

To generate thrust, the motor means 28 spins the rotor 32 together with the magnetic field 36 at the predetermined angular velocity ω to endow the magnetic field 36 with an angular momentum and energy of motion. The magnetic interactions between the spinning magnetic field 36, in motion through the magnetic field space of the stationary magnetic field 40; employs the angular momentum and energy of motion in the magnetic field 36 in a cooperation that generate the Lorentz force 14 as propellantless thrust for propulsion.

As an operation that generates the Lorentz force 14, the axial magnetic field 36 applies a magnetic field force on the radial magnetic field 40; without the reply of an equal and opposite reaction on the magnetic field 36 from the radial magnetic field 40. This is in agreement with Ampère's findings about the forces between orthogonal electric currents. However, instead of electric currents, the Lorentz force 14 is the resultant force produced with the magnetic fields interaction between the angularly disposed axial and radial magnetic fields involved. That arrangement also includes the orthogonal magnetic fields arrangement, in addition to all other possible angles between the magnetic field 36 and the magnetic field 40. The rotor 32 can also be manufactured as a multi-poles magnetic field type magnet in either as a single magnetic body piece or as a plurality of permanent magnets or electromagnets as the rotor 32 assembly.

The stator support 42 and the motor support 30 are attached to the base 44. The motor 28 spins the magnetic rotor 32 together with the magnetic field 36 with the predetermined angular velocity ω during the time period of internal magnetic field interaction between the magnetic field 36 and the stationary magnetic field 40.

The magnet stator 38 is annular to allow for the magnetic field 40 to radiate inward toward the center of the magnet 38 in order to provide a magnetic field zone for magnetic interaction with the magnetic field 36. In addition to annular, the magnet 38 can take other suitable geometric forms as needed. The magnet stator 38 can be construed as a multi-poles magnet with alternating north-south magnetic poles. Furthermore, the magnetic interactions between the angularly disposed magnetic fields 36 and 40 can also take place within either one or both of the magnetic field generating bodies of the magnet rotor 32 and the magnet stator 38. In which case, the magnetic field 36 also penetrates into the physical body of the stator 38; or the magnetic field penetrates into the rotor magnet 32, or both magnetic fields 36 and 40 penetrate into the physical bodies of the rotor 32 and the stator 38.

FIG. 4 exemplifies how the first magnetic field 36 together with the magnet rotor 32 spin with the angular velocity ω while penetrating into the magnetic stator stationary magnetic field space comprising the angularly disposed magnetic field 40, in order to interact magnetically and generate the Lorentz force 14 with the magnetic interactions between, the moving magnetic field 36 in motion through the stationary magnetic field 40. The magnet rotor 32 is in alignment with the stator 38; while simultaneously angularly positioned, and axially disposed at a predetermined distance from the magnet stator 38.

In any order, in addition to a variety of angles, the rotor 32 magnetic field 36 N-S generates and provides magnetic field force vector components in the axial direction, parallel to the motor shaft 34. In contrast, the n-s magnetic field vector force direction for the magnetic field 40 is radially disposed, and angularly disposed at predetermined angles that include the orthogonal orientation in relation to the axial magnetic field 36. By maintaining the orthogonal relationship between the magnetic field 36 and the magnetic field 40, a substantially optimum propellantless thrust output can be achieved. In the orthogonal magnetic field configuration, the propellantless thrust the propulsion system 26 generates is produced without an equal and opposite reaction, without the expulsion of propellant, and without reliance on an external mass to react against.

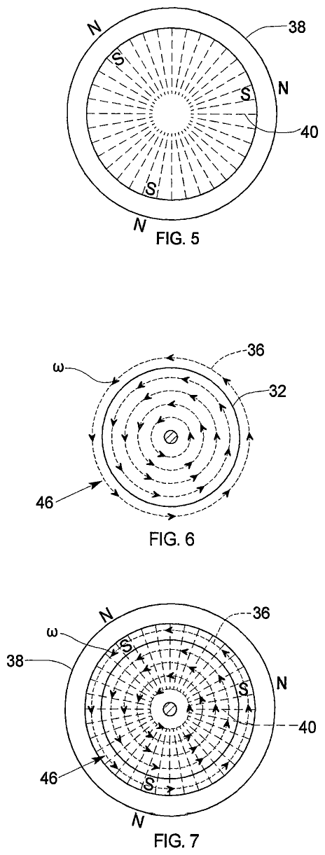

### FIG. 5, FIG. 6, and FIG. 7

FIG. 5, FIG. 6, and FIG. 7 exemplify how propellantless thrust is produced with the magnetic field interactions between; the magnetic field 36 in motion through the stationary magnetic field space of the stator magnetic field 40. FIG. 5, FIG. 6, and FIG. 7 show the stator magnet 38 can be ascertained as annular, with predetermined axial and radial dimensions. But not limited to annular since other geometric shapes are adaptable to the function that provides a magnetic field. The stator 38 can also be designed as a multi-pole magnetic field type magnet.

In FIG. 3 and FIG. 6, the magnet rotor 32 is shown as a cylindrical body of predetermined axial and radial dimensions. The rotor 32 is shown with a singular magnetic field emanating from the North-South magnetic poles. However, the rotor 32 can also be constructed as a permanent magnet or as an electromagnet array with multiple magnetic poles.

In many instances, magnetic fields are often shown with magnetic field lines of force for ease of visualization. Similarly, the magnetic fields 36 and 40 are also shown with magnetic field lines of force for exemplification. In addition to annular, other polygon body shapes of magnets and electromagnets are also suitable for the stator 38 construction as a source of magnetic field.

Accordingly, FIG. 5 is an isolated front view of the stator magnet 38. Relative to the base 44, the stator 38 with magnetic field 40 is in a predetermined stationary magnetic field frame of reference relative to the position of the spinning axial magnetic field 36. FIG. 5 illustrates the magnetic field 40 with radial magnetic field lines of force to illustrate the stationary magnetic field zone where the magnetic field 36 interact magneto dynamically with the magnetic field 40. The magnet stator 38 shows the North Pole N and the South Pole S magnetic vector orientation.

FIG. 6 shows a front view of the magnet rotor 32 spinning together with the magnetic field 36 with the predetermined angular velocity ω. The gyrations of the rotor 32 transfers to the magnetic field 36 an angular momentum and energy of motion to interact magnetically with the magnetic field 40; in order to generate the propellantless and propulsive Lorentz force 14. The gyrations of the axial magnetic field 36 are shown with dashed magnetic field lines of force with arrows to indicate the angular velocity ω spin direction. The magnetic field 36 gyrations are shown as a spinning magnetic field vortex 46 in the counterclockwise direction with the rotor 32 angular velocity ω.

The rotor 32 can gyrate either clockwise or counterclockwise. Even though the orthogonal alignment between magnetic fields is the optimal angular spin vector orientation; nevertheless, for application in numerous embodiments, the magnetic fields can be arranged in a variety of angular orientation and distances apart by taking into account the magnetic field. The magnetic field strength increases and decreases inversely proportional to the square of the distance, in addition to the angle between the fields. The magnetic field vector orientation between the rotor 32 and the stator 38 can include an angularly disposed axial vector inclination in addition to a lateral radial vector angular orientation (forward, rearward, or lateral).

FIG. 7 illustrates the dynamic magnetic field interactions between the stationary magnetic field 40 and the superimposed axial magnetic field 36. The spinning motion of the magnetic field 36 generates the magnetic field vortex 46 with a content of magnetic field energy, angular momentum, and energy of motion. FIG. 4 shows a lateral view of the axial magnetic field 36 as orthogonal to the radial magnetic field 40.

FIG. 7 shows the superimposed movement of the magnetic field 36 in motion through the magnetic field 40 space with the angular velocity ω. The magnetic field 36 lines of force are angularly disposed and in this case, perpendicular to the radial magnetic field 40 lines of force. Within the magnet 38 internal space, the superimposed magnetic field vortex 46 over the magnetic field 40; illustrates the movement of the axial magnetic field 36 in motion with the angular velocity ω within the radial magnetic field 40 involved in a magnetic field interaction between the fields 36 and 40. The magnetic field 36 lines of force spinning with the angular velocity ω penetrates into the magnetic field 40, and move through the perpendicular magnetic field 40 radial lines of force. The orthogonal dynamic relationship between the movement of the magnetic field 36 and the stationary magnetic field 40 makes possible the NTLE effect that generates propellantless thrust.

The magnetic field vortex 46, as a byproduct of the spinning magnetic field 36; is orthogonal to the radial magnetic field 40 and carries angular momentum and energy of motion that interact magnetically with the radial and orthogonal stationary magnetic field 40. The movement of the spinning magnetic field 36 as a vortex within the magnetic field space of the stationary magnetic field 40; transfer angular momentum and energy of motion to the magnetic field 40 that also generates the propellantless Lorentz force 14. The magnetic field vortex energy and momentum transfer from the vortex 46 to the magnetic field 40 is a magnetic pressure that generates the Lorentz force 14 without the ejection of propellant, without reaction, and without reliance on an external mass to react against. The spinning magnet 36, as a component of the magnetic field vortex 46; exerts a magnetic field pressure force on the angularly disposed magnetic field 40 and generate the Lorentz Force 14 without an equal and opposite Newtonian reaction response from the magnetic field 40.

In a reduction to practice, successful tests were conducted with commercially available electric motors and Neodymium magnets in the stator and the rotor, as well as with electromagnets.

The assembled test components were mounted on a platform with ball bearing rollers to allow for the platform free movement in any direction. For the experiments, the supporting electronics to control the motor speed, and the three phase motor(s) used; is of the type commonly found in hobby type drones and model airplanes powered by LiPo batteries.

However, the functional empirical test to demonstrate the operation that generates propellantless thrust can also be done with electromagnets, or in a combination of permanent magnets and electromagnets. In the herein description of the Magnetodynamic prime mover, the word magnet is used to comprise and refer to the use of electromagnets as well as permanent magnets as the sources of magnetic field in either one or both, the rotor and the stator. In regard to the inclusion of electromagnets and electric motors to generate the magnetodynamic propellantless thrust; the relevant connections, cables, and power supplies are not shown because these items can be added and designed be the engineers and technical personnel in accordance with the standards and the available components technology at the time of implementation.

### CONCLUSIONS, RAMIFICATIONS, AND SCOPE

The disclosed magnetodynamic propulsion system is a novel prime mover utilizing a new method of magnetic field propulsion comprising the synergy in the magnetic fields cooperation and interactions between; a magnetic field in motion through the magnetic field space of a stationary magnetic field.

The Magnetodynamic propulsion is adaptable to a variety of motor means such as an electric motor, an internal combustion engine with or without a transmission, or a turbine to turn a single or a plurality of rotors. The gyrations of the rotor convey the rotor's magnetic field of permanent magnet(s) and electromagnet(s), with angular momentum and energy of motion; useful for the production of propellantless thrust, as the resultant consequence of magnetic interactions between magnetic fields in motion through the magnetic field space of a stationary magnetic field. Similarly, the same operation of propellantless thrust output can be performed with a single or a plurality of stationary magnetic fields, or a single or a plurality of magnetic fields in motion by spinning a second magnetic field in the opposite direction to the first magnetic field. An axial magnetic field can spin in one direction; while simultaneously, the radial magnetic field can rotate in the opposite direction through the axial magnetic field space. This particular synergy of magnetic fields interaction generates an enhanced thrust output with both magnetic fields in motion.

In another embodiment, the axial magnetic field can be stationary while the radial magnetic field gyrates to generate propellantless propulsion.

Therefore, the teachings herein can be carried out in a variety of embodiments, derivatives and permutation in accordance with the use of angularly dispose magnetic fields interaction. When one magnetic field in motion moves through the magnetic field space of another magnetic field, the magnetic interaction between the fields interact and generate propelling directional Lorentz forces as thrust for propellantless propulsion.

The rotor that generates the magnetic field can be assembled to include a Halbach array of permanent magnets and/or electromagnets. Similarly, the stator as a source of magnetic field may also include a Halbach array assembly of permanent magnets and/or electromagnets. This particular embodiment may also be carried out as a single or a plurality of Habach arrays rotors interacting magnetically with a single or a plurality of Halbach array stators.

Another embodiment comprise a rotor with a plurality of magnets with a N-S tangential magnetic field on the rotor for magnetic interactions with another stator magnet with a radial N-S magnetic or with electromagnets on either one or both, the stator and the rotor with or without a combination of Halbach arrays.

Additional embodiments comprise an axial magnetic field center magnet in between two radial magnetic field stator magnets comprising electromagnets. One electromagnet stator is in the front of the center rotor magnet; and the other stator magnet on the center magnet back side.

To generate the Lorentz forces for propulsion with the energy of the center magnets gyrations, one stator magnet at a time is energized. When the front stator magnet is energized, the direction of the thrust produced is toward the front. Similarly, when the rear stator magnet is energized, the thrust produced is rearward. In this configuration, the propulsion drive can be employed to propel a vehicle in the forward direction as well in reverse.

In an airplane, the propulsion system can propel the craft forward thrust for takeoff and flight, and also provide reverse thrust during landing to slow down and even stop the craft. The same propulsion is also adaptable for use in passenger cars to drive the car forward or in reverse.

The magnitude of the propulsive Lorentz forces can be considerably enhanced with superconductor magnets. With superconductivity, propellantless propulsion by way of NTLE will increase many times over to a level of magnitude that may not be obtainable with ordinary permanent magnets and electromagnets.

The embodiment shown can be built with commercially available components such as permanent magnets, electromagnets, electric motors, and electronic components. Electric energy for electric motors as the means to spin a rotor; and to energize the electromagnets that generate the magnetic fields that generate the Lorentz forces can be supplied with commercially available batteries, fuel cells, and other suitable sources of electric power.

The present embodiments have been described with reference to the accompanying drawings with like numbers referring to like elements throughout the descriptions. The embodiments may be represented in many different forms and should not be construed as limitations.

I claim:

1. A propulsion system comprising:
motor means to spin a magnet rotor at a predetermined angular velocity in order to provide an axial magnetic field in motion with a predetermined angular velocity,
a magnet stator generating a radial magnetic field for magnetic field interaction with said magnetic field in motion,
whereby said axial magnetic field in motion interact magnetically with said stationary magnetic field to generate a Lorentz force for propulsion.

2. A propulsion method comprising:
providing an axial magnetic field in motion at a predetermined angular velocity, with a predetermined angular momentum, and a predetermined energy of motion,
providing a stationary radial magnetic field for magnetic field interaction with said axial magnetic field in motion,
whereby the magnetic field interaction between said axial magnetic field in motion with said stationary magnetic field generate a Lorentz force for propulsion.
